(19) United States
(12) Patent Application Publication
(10) Pub. No.: US 2023/0099582 A1
(43) Pub. Date: Mar. 30, 2023

(54) MANAGEMENT SYSTEM FOR TRANSPORT VEHICLE AND MANAGEMENT METHOD FOR TRANSPORT VEHICLE

(71) Applicant: Komatsu Ltd., Tokyo (JP)

(72) Inventors: Atsushi Sakai, Tokyo (JP); Kazuma Takeda, Tokyo (JP); Kenta Osagawa, Tokyo (JP)

(73) Assignee: Komatsu Ltd., Tokyo (JP)

(21) Appl. No.: 17/908,400

(22) PCT Filed: Mar. 23, 2021
(86) PCT No.: PCT/JP2021/011924

§ 371 Date: Aug. 31, 2022

(30) Foreign Application Priority Data
Apr. 27, 2020 (JP) 2020-078712

(51) Int. Cl. G01C 21/34; E21C 47/00; G05D 1/02; G08G 1/00; G06Q 50/02

(52) U.S. Cl. CPC G01C 21/3407; E21C 47/00; G05D 1/02; G06Q 50/02; G08G 1/00; G05D 2201/0202

(57) ABSTRACT

A management system for a transport vehicle includes a storage unit that stores a traveling path outline indicating an outline of a traveling path at a work site and an intersection outline indicating an outline of an intersection at the work site, a designation unit that designates a start point of traveling of the transport vehicle at the work site and an end point of traveling of the transport vehicle, and a connection unit that generates a traveling area outline by connecting the traveling path outline and the intersection outline on the basis of the start point and the end point designated by the designation unit.

### FIELD

The present disclosure relates to a management system for a transport vehicle and a management method for a transport vehicle.

### BACKGROUND

In a wide-area work site such as a mine, a transport vehicle that travels unattended is used for transport work. A traveling course of the transport vehicle is set at the work site. The traveling course is set so as to connect a loading place of the work site and a soil discharging place. The transport vehicle is controlled to travel between the loading place and the soil discharging place along the traveling course. As a method of setting a traveling course, a method of setting a traveling course on a basis of a topography of a work site is known. In a method of setting a traveling course on the basis of a topography of a work site, a survey vehicle, which is a manned vehicle, travels along a boundary line of a topography such as a bank or a cliff, and an outline of a traveling path of a transport vehicle is set based on a traveling trajectory of the survey vehicle. After the outline of the traveling path is set, the traveling course is set at a position offset from the outline of the traveling path to the traveling path by a specified amount.

### CITATION LIST

### Patent Literature

Patent Literature 1: JP 2012-118694 A

### SUMMARY

### Technical Problem

There may be an intersection between the loading place and the soil discharging place. When there is an intersection at a work site, it is desired to smoothly set a traveling course.

An object of the present disclosure is to smoothly set a traveling course of a transport vehicle. Solution to Problem

According to an aspect of the present invention, a management system for a transport vehicle, the management system comprises: a storage unit that stores a traveling path outline indicating an outline of a traveling path at a work site and an intersection outline indicating an outline of an intersection at the work site; a designation unit that designates a start point of traveling of the transport vehicle and an end point of traveling of the transport vehicle at the work site; and a connection unit that generates a traveling area outline by connecting the traveling path outline and the intersection outline on a basis of the start point and the end point designated by the designation unit.

### Advantageous Effects of Invention

According to the present disclosure, it is possible to smoothly set a traveling course of a transport vehicle.

### BRIEF DESCRIPTION OF DRAWINGS

FIG. 1 is a schematic diagram illustrating a management system for a transport vehicle according to an embodiment.

FIG. 2 is a schematic diagram illustrating a work site according to the embodiment.

FIG. 3 is a functional block diagram illustrating a management device according to the embodiment.

FIG. 4 is a schematic diagram for explaining a traveling path outline according to the embodiment.

FIG. 5 is a schematic diagram for explaining an intersection outline according to the embodiment.

FIG. 6 is a schematic diagram for explaining processing of a designation unit according to the embodiment.

FIG. 7 is a schematic diagram for explaining processing of a connection unit according to the embodiment.

FIG. 8 is a schematic diagram for explaining a connection procedure between a traveling path outline and an intersection outline according to the embodiment.

FIG. 9 is a schematic diagram for explaining a connection procedure between a traveling path outline and an intersection outline according to the embodiment.

FIG. 10 is a schematic diagram for explaining processing of a reference line creating unit according to the embodiment.

FIG. 11 is a schematic diagram for explaining processing of a course data creating unit according to the embodiment.

FIG. 12 is a flowchart illustrating a method of creating course data according to the embodiment.

FIG. 13 is a schematic diagram for explaining a procedure for generating a traveling area outline according to the embodiment.

FIG. 14 is a schematic diagram for explaining a procedure for generating a traveling area outline according to the embodiment.

FIG. 15 is a schematic diagram for explaining a reference line according to the embodiment.

FIG. 16 is a schematic diagram for explaining processing of the connection unit according to the embodiment.

FIG. 17 is a schematic diagram for explaining processing of the connection unit according to the embodiment.

FIG. 18 is a schematic diagram for explaining processing of a course data creating unit according to a modification.

FIG. 19 is a schematic diagram for explaining processing of a designation unit according to the modification.

### DESCRIPTION OF EMBODIMENTS

Hereinafter, embodiments according to the present disclosure will be described with reference to the drawings, but the present disclosure is not limited thereto. The components of the embodiments described below can be combined as appropriate. In addition, some components are not used sometimes.

### Management System

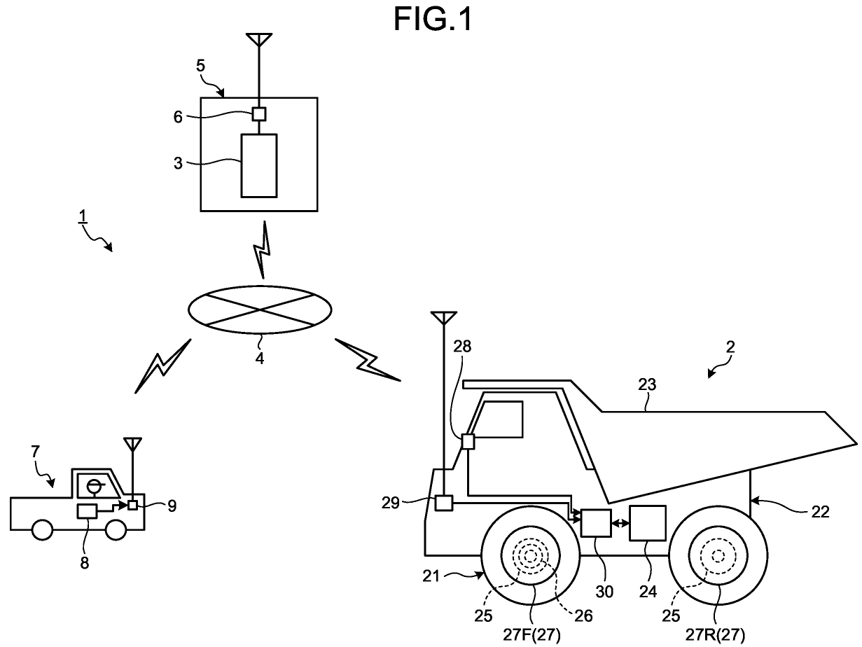

FIG. 1 is a schematic diagram illustrating a management system 1 for a transport vehicle 2 according to an embodiment. The transport vehicle 2 is an unmanned vehicle. The unmanned vehicle refers to a vehicle that operates in an unmanned manner without depending on a driving operation of a driver. The transport vehicle 2 operates at a work site. In the embodiment, the transport vehicle 2 is an unmanned dump truck that travels in an unmanned manner at a work site and transports a cargo.

The management system 1 includes a management device 3 and a communication system 4. The management device 3 includes a computer system. The management device 3 is installed in a control facility 5 of the work site. The communication system 4 executes communication between the management device 3 and the transport vehicle 2. A wireless communication device 6 is connected to the management device 3. The communication system 4 includes a wireless communication device 6. The management device 3 and the transport vehicle 2 wirelessly communicate with each other via the communication system 4.

### Transport Vehicle

The transport vehicle 2 includes a traveling device 21, a vehicle body 22 supported by the traveling device 21, a dump body 23 supported by the vehicle body 22, a control device 30, a position detection device 28, and a wireless communication device 29.

The traveling device 21 includes a drive device 24, a brake device 25, a steering device 26, and wheels 27. The wheels 27 include front wheels 27F and rear wheels 27R.

The drive device 24 generates a driving force for accelerating the transport vehicle 2. The drive device 24 includes an internal combustion engine such as a diesel engine. Note that the drive device 24 may include an electric motor. The power generated by the drive device 24 is transmitted to the rear wheels 27R. The brake device 25 generates a braking force for decelerating or stopping the transport vehicle 2. The steering device 26 can adjust the traveling direction of the transport vehicle 2. The traveling direction of the transport vehicle 2 includes the direction of the front portion of the vehicle body 22. The steering device 26 adjusts the traveling direction of the transport vehicle 2 by steering the front wheels 27F. As the wheels 27 rotate, the transport vehicle 2 self-travels.

The control device 30 is disposed on the transport vehicle 2. The control device 30 can communicate with the management device 3 existing outside the transport vehicle 2. The control device 30 outputs an accelerator command for actuating the drive device 24, a brake command for actuating the brake device 25, and a steering command for actuating the steering device 26. The drive device 24 generates a driving force for accelerating the transport vehicle 2 based on the accelerator command output from the control device 30. By adjusting the output of the drive device 24, the traveling speed of the transport vehicle 2 is adjusted. The brake device 25 generates a braking force for decelerating the transport vehicle 2 based on the brake command output from the control device 30. The steering device 26 generates a force for changing the direction of the front wheels 27F in order to make the transport vehicle 2 go straight or turn based on the steering command output from the control device 30.

The position detection device 28 detects the position of the transport vehicle 2. The position of the transport vehicle 2 is detected using the Global Navigation Satellite System (GNSS). The global navigation satellite system includes a Global Positioning System (GPS). The global navigation satellite system detects a position in a global coordinate system defined by coordinate data of latitude, longitude, and altitude. The global coordinate system is a coordinate system fixed to the earth. The position detection device 28 includes a GNSS receiver and detects the position of the transport vehicle 2 in the global coordinate system.

The wireless communication device 29 wirelessly communicates with the management device 3. The communication system 4 includes a wireless communication device 29.

### Survey Vehicle

At the work site, not only the transport vehicle 2 but also a survey vehicle 7 is operated. The survey vehicle 7 is a manned vehicle. The manned vehicle refers to a vehicle that operates based on the driving operation of the driver on board. The outer shape of the survey vehicle 7 is smaller than the outer shape of the transport vehicle 2. The survey vehicle 7 measures a survey line 44 to be described later.

The survey vehicle 7 includes a position detection device 8 and a wireless communication device 9.

The position detection device 8 detects the position of the survey vehicle 7. The position of the survey vehicle 7 is detected using a global navigation satellite system (GNSS). The position detection device 8 includes a GNSS receiver and detects the position of the survey vehicle 7 in the global coordinate system.

The wireless communication device 9 wirelessly communicates with the management device 3. The communication system 4 includes a wireless communication device 9.

### Work Site

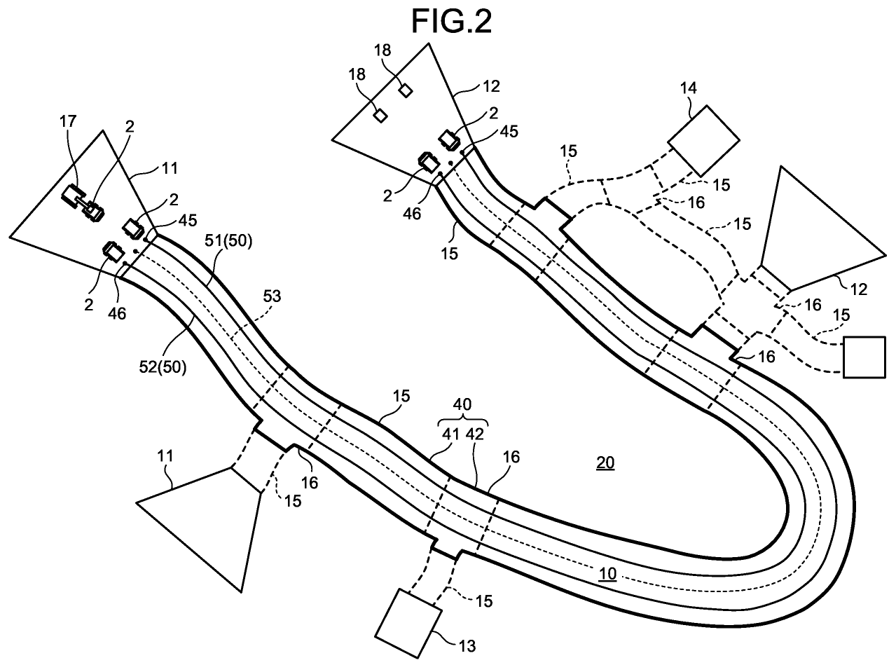

FIG. 2 is a schematic diagram illustrating a work site according to the embodiment. In the embodiment, the work site is a mine. The mine refers to a place or a place of business where minerals are mined. Examples of the mine include a metal mine for mining metal, a non-metal mine for mining limestone, and a coal mine for mining coal. Examples of the cargo to be transported by the transport vehicle 2 include ore or earth and sand excavated in a mine.

In the embodiment, a local coordinate system is set at the work site. The local coordinate system refers to a coordinate system based on an origin and a coordinate axis set at an arbitrary position of the action site. The position of the global coordinate system and the position of the local coordinate system can be transformed using transformation parameters.

The work site is provided with a loading place 11, a soil discharging place 12, a parking lot 13, an oil supply station 14, a traveling path 15, and an intersection 16. The loading place 11 is an area in which a loading operation of loading a cargo on the transport vehicle 2 is performed. In the loading place 11, a loader 17 such as an excavator operates. The soil discharging place 12 is an area in which discharging work for discharging a cargo from the transport vehicle 2 is performed. The soil discharging place 12 is provided with, for example, a crusher 18. The parking lot 13 is an area in which the transport vehicle 2 is parked. The oil supply station 14 is an area in which oil is supplied to the transport vehicle 2.

The traveling path 15 is connected to each of the loading place 11, the soil discharging place 12, the parking lot 13, and the oil supply station 14. The traveling path 15 is provided so as to connect at least the loading place 11 and the soil discharging place 12. The traveling path 15 refers to an area where the transport vehicle 2 traveling toward at least one of the loading place 11, the soil discharging place 12, the parking lot 13, and the oil supply station 14 travels. The intersection 16 refers to an area where a plurality of traveling paths 15 intersect or an area where one traveling path 15 branches into a plurality of traveling paths 15. The transport vehicle 2 travels on the traveling path 15 and the intersection 16.

A traveling area 10 and a prohibited area 20 are set at the work site. The traveling area 10 is an area where the transport vehicle 2 is permitted to travel. The prohibited area 20 is an area where the transport vehicle 2 is prohibited to travel. The traveling area 10 includes the loading place 11, the soil discharging place 12, the parking lot 13, the oil supply station 14, the traveling path 15, and the intersection 16.

The traveling area 10 is defined by a traveling area outline 40. The traveling area outline 40 is a dividing line that divides the traveling area 10 and the prohibited area 20. The traveling area 10 is an area on one side of the traveling area outline 40, and the prohibited area 20 is an area on the other side of the traveling area outline 40. When the traveling area outline 40 surrounds the traveling area 10, the traveling area 10 is an area surrounded by the traveling area outline 40. Note that the traveling area outline 40 does not need to surround the traveling area 10. The traveling area outline 40 may linearly divide the traveling area 10 and the prohibited area 20, for example.

The traveling area outline 40 includes a traveling path outline 41 indicating the outline of the traveling path 15 and an intersection outline 42 indicating the outline of the intersection 16. The traveling area outline 40 is generated by connecting the traveling path outline 41 and the intersection outline 42.

The transport vehicle 2 operates at the work site on the basis of course data from the management device 3. The course data includes a traveling course 50 indicating a target traveling route of the transport vehicle 2, a target traveling speed of the transport vehicle 2, and a target traveling direction of the transport vehicle 2. The traveling course 50 is set in the traveling area 10. The transport vehicle 2 travels in the traveling area 10 along the traveling course 50.

A reference line 53 is set in the traveling area 10 on the basis of the traveling area outline 40. The traveling course 50 is set based on the reference line 53. In the embodiment, the traveling course 50 is set on both sides of the reference line 53. In the embodiment, the traveling course 50 includes a first traveling course 51 and a second traveling course 52. At least a part of the first traveling course 51 is set on one side of the reference line 53. At least a part of the second traveling course 52 is set on the other side of the reference line 53. For example, the transport vehicle 2 travels from the loading place 11 to the soil discharging place 12 along the first traveling course 51, and travels from the soil discharging place 12 to the loading place 11 along the second traveling course 52.

Note that the traveling course 50 may be set only on one side of the reference line 53. For example, the first traveling course 51 may be created and the second traveling course 52 does not need to be created. The traveling course 50 may be set to cross the reference line 53.

The position of the traveling area outline 40, the position of the reference line 53, and the position of the traveling course 50 are defined in the local coordinate system.

### Management Device

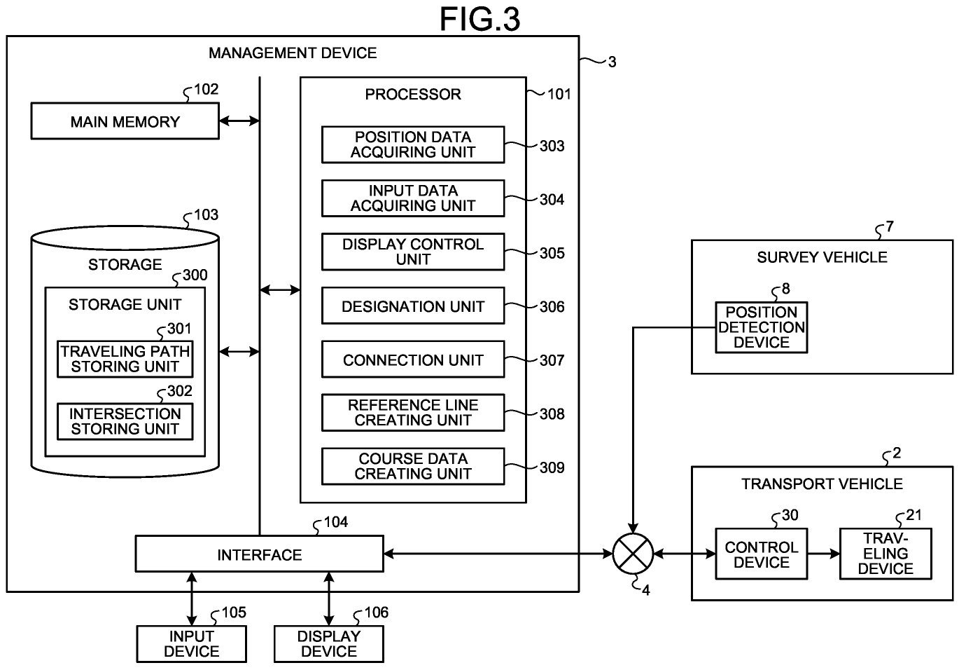

FIG. 3 is a functional block diagram illustrating the management device 3 according to the embodiment. The management device 3 includes a computer system. The management device 3 includes a processor 101 such as a central processing unit (CPU), a main memory 102 including a nonvolatile memory such as a read only memory (ROM) and a volatile memory such as a random access memory (RAM), a storage 103, and an interface 104 including an input/output circuit.

The management device 3 wirelessly communicates with each of the transport vehicle 2 and the survey vehicle 7 via the communication system 4. In addition, the management device 3 is connected to each of an input device 105 and a display device 106. The input device 105 and the display device 106 are installed in the control facility 5. Examples of the input device 105 include a keyboard, a mouse, and a touch panel for a computer. The input data generated by operating the input device 105 is output to the management device 3. The display device 106 operates based on display data output from the management device 3. Examples of the display device 106 include a flat panel display such as a liquid crystal display (LCD) or an organic electroluminescence display (OELD).

The management device 3 includes a storage unit 300, a position data acquiring unit 303, an input data acquiring unit 304, a display control unit 305, a designation unit 306, a connection unit 307, a reference line creating unit 308, and a course data creating unit 309. The processor 101 functions as the position data acquiring unit 303, the input data acquiring unit 304, the display control unit 305, the designation unit 306, the connection unit 307, the reference line creating unit 308, and the course data creating unit 309. The storage 103 functions as the storage unit 300.

The storage unit 300 stores a traveling path outline 41 indicating an outline of the traveling path 15 at the work site and an intersection outline 42 indicating an outline of the intersection 16 at the work site. The storage unit 300 includes a traveling path storing unit 301 that stores the traveling path outline 41 and an intersection storing unit 302 that stores the intersection outline 42.

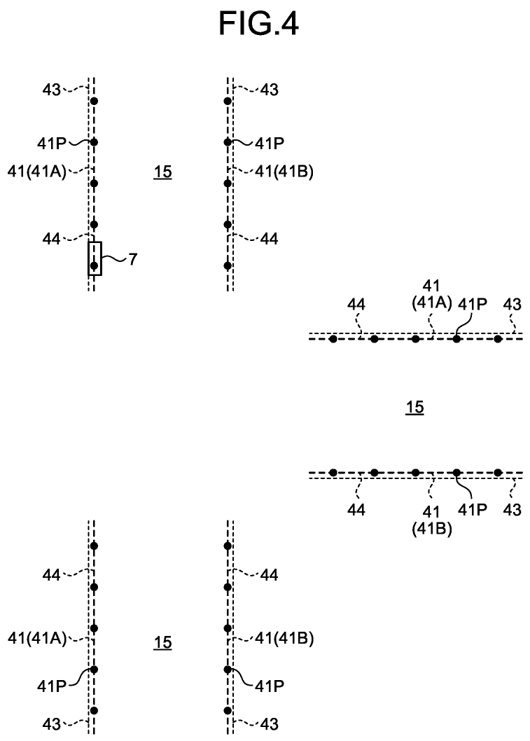

FIG. 4 is a schematic diagram for explaining the traveling path outline 41 according to the embodiment. As illustrated in FIG. 4, the traveling path outline 41 is an aggregate of a plurality of traveling path outline points 41P set at intervals. The interval between the traveling path outline points 41P may be uniform or may be different. The traveling path outline 41 is defined by a trajectory passing through the plurality of traveling path outline points 41P. The position of the traveling path outline 41 is defined in the local coordinate system.

In the embodiment, the traveling path outline 41 is a survey line 44 measured by the survey vehicle 7. The survey line 44 is an imaginary line that divides the traveling area 10 and the prohibited area 20.

When the survey line 44 is measured, the survey vehicle 7 travels along a boundary line 43 of the topography of the work site. The boundary line 43 of the topography refers to a characteristic portion that can divide a work site such as a bank or a cliff. When the work site is designed by a design method such as computer aided design (CAD), the boundary line 43 may be derived from design data of the work site.

The survey vehicle 7 travels along the boundary line 43 while detecting the position of the global coordinate system by the position detection device 8. The position of the traveling path outline point 41P is the position of the survey vehicle 7 detected by the position detection device 8. The survey line 44 is a traveling trajectory of the survey vehicle 7 traveling along the boundary line 43.

The position data of the survey vehicle 7 detected by the position detection device 8 is transmitted to the management device 3 via the communication system 4. The position data acquiring unit 303 acquires position data of the survey vehicle 7 detected by the position detection device 8. The position of the traveling path outline point 41P is defined in the global coordinate system. The position data acquiring unit 303 converts the position of the traveling path outline point 41P in the global coordinate system into the position in the local coordinate system. The position data acquiring unit 303 generates the traveling path outline 41 from the plurality of traveling path outline points 41P.

The traveling path storing unit 301 stores the positions of the plurality of traveling path outline points 41P. The traveling path storing unit 301 stores the position of the traveling path outline 41. The position of the traveling path outline point 41P stored in the traveling path storing unit 301 is a position in the local coordinate system. The position of the traveling path outline 41 stored in the traveling path storing unit 301 is a position in the local coordinate system.

The traveling path outline 41 includes a traveling path outline 41A on one end side in the width direction of the traveling path 15 and a traveling path outline 41B on the other end side in the width direction. In the width direction of the traveling path 15, the traveling path outline 41A on one end side and the traveling path outline 41B on the other end side face each other. The traveling path 15 exists between the traveling path outline 41A on one end side and the traveling path outline 41B on the other end side. In a state where the traveling course 50 is created on the traveling path 15, the traveling path outline 41A on one end side exists on one end side of the traveling course 50, and the traveling path outline 41B on the other end side exists on the other end side of the traveling course 50.

Note that the traveling path outline 41 may be derived from design data of the work site. Note that the traveling path outline 41 may be defined by measurement data of the topography of a flying object flying along the traveling path outline 41. Examples of the flying object include a drone. A three-dimensional measurement device is mounted on the flying object. Examples of the three-dimensional measurement device include a stereo camera and a laser range finder. Note that the traveling path outline 41 may be derived by actually surveying the topography of the work site. The traveling path outline 41 may be derived from the aerial photograph of the work site.

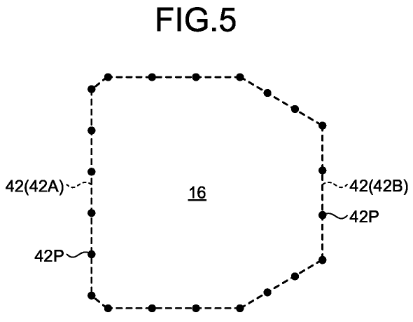

FIG. 5 is a schematic diagram for explaining the intersection outline 42 according to the embodiment. As illustrated in FIG. 5, the intersection outline 42 is an aggregate of a plurality of intersection outline points 42P set at intervals. The interval between the intersection outline points 42P may be uniform or may be different. The intersection outline 42 is defined by a trajectory passing through the plurality of intersection outline points 42P. The position of the intersection outline 42 is defined in the local coordinate system.

Similarly to the traveling path outline 41, the intersection outline 42 is the survey line 44 measured by the survey vehicle 7. Since the method of generating the intersection outline 42 is similar to that of the traveling path outline 41, the description thereof will be omitted.

Note that, similarly to the traveling path outline 41, the intersection outline 42 may be derived from design data of the work site, or may be defined by measurement data of a topography by a flying object flying along the intersection outline 42. The intersection outline 42 may be derived by actually surveying the topography of the work site, or the intersection outline 42 may be derived from an aerial photograph of the work site.

The intersection storing unit 302 stores the positions of the plurality of intersection outline points 42P. The intersection storing unit 302 stores the position of the intersection outline 42. The position of the intersection outline point 42P stored in the intersection storing unit 302 is a position in the local coordinate system. The position of the intersection outline 42 stored in the intersection storing unit 302 is a position in the local coordinate system.

The intersection outline 42 includes an intersection outline 42A on one end side connected to the traveling path outline 41A on one end side and an intersection outline 42B on the other end side connected to the traveling path outline 41B on the other end side. The intersection 16 exists between the intersection outline 42A on one end side and the intersection outline 42B on the other end side. In a state where the traveling course 50 is created at the intersection 16, the intersection outline 42A on one end side exists on one end side of the traveling course 50, and the intersection outline 42B on the other end side exists on the other end side of the traveling course 50.

The input data acquiring unit 304 acquires input data from the input device 105. The input device 105 is operated by the administrator to create input data. The input data acquiring unit 304 acquires the input data generated by the input device 105.

The display control unit 305 causes the display device 106 to display display data.

The designation unit 306 designates a start point 45 of traveling of the transport vehicle 2 at the work site, an intersection 16 through which the transport vehicle 2 passes, and an end point 46 of traveling of the transport vehicle 2. In the embodiment, the start point 45 is set in the loading place 11 or the soil discharging place 12. The end point 46 is set in the soil discharging place 12 or the loading place 11. When designating the start point 45 as the loading place 11, the designation unit 306 designates the end point 46 as the soil discharging place 12. When designating the start point 45 as the soil discharging place 12, the designation unit 306 designates the end point 46 as the loading place 11. When there are a plurality of intersections 16 between the start point 45 and the end point 46, the designation unit 306 designates the intersection 16 through which the transport vehicle 2 passes.

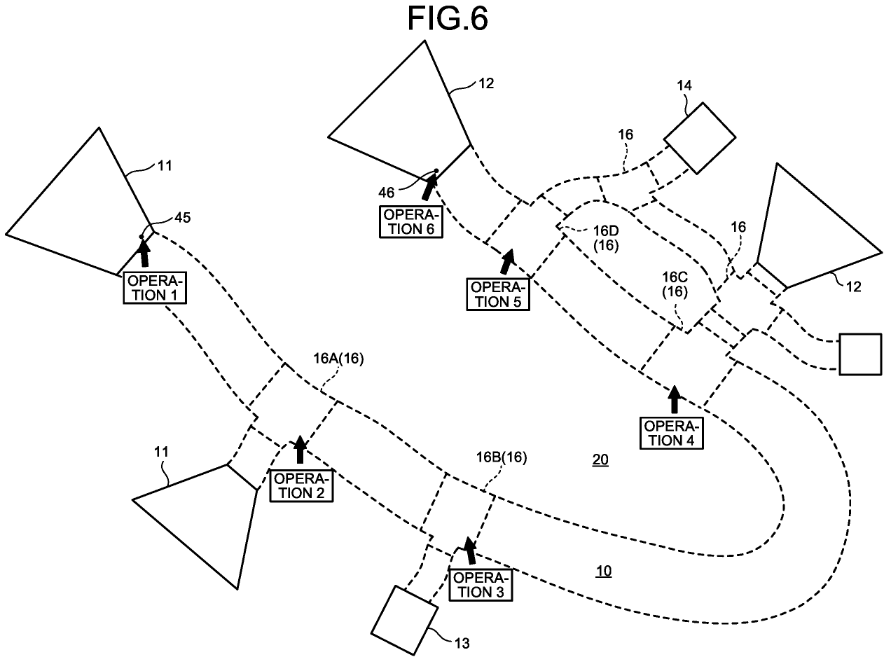

FIG. 6 is a schematic diagram for explaining processing of the designation unit 306 according to the embodiment. The designation unit 306 designates the start point 45, the intersection 16 through which the transport vehicle 2 passes, and the end point 46 on the basis of the input data from the input device 105. The input device 105 is operated by the administrator to create input data.

As illustrated in FIG. 6, the display control unit 305 causes the display device 106 to display the image of the work site including the traveling area 10. The display device 106 displays a bird’s eye image of the work site. While checking the image of the work site displayed on the display device 106, the administrator operates the input device 105 to designate the start point 45, the intersection 16 through which the transport vehicle 2 passes, and the end point 46.

In the example illustrated in FIG. 6, the administrator first designates the start point 45 by operating the input device 105 (operation 1).

After designating the start point 45, the administrator operates the input device 105 to designate a first intersection 16A through which the transport vehicle 2 departing from the start point 45 is desired to pass first (operation 2). After designating the first intersection 16A, the administrator operates the input device 105 to designate a second intersection 16B through which the transport vehicle 2 is desired to pass next after the first intersection 16A (operation 3). After designating the second intersection 16B, the administrator operates the input device 105 to designate a third intersection 16C through which the transport vehicle 2 is desired to pass next after the second intersection 16B (operation 4). After designating the third intersection 16C, the administrator operates the input device 105 to designate a fourth intersection 16D through which the transport vehicle 2 is desired to pass next after the third intersection 16C (operation 5).

After designating the intersection 16 through which the transport vehicle 2 is desired to pass in the order desired to pass, the administrator operates the input device 105 to finally designate the end point 46 (operation 6) .

The designation unit 306 designates one start point 45, a plurality of intersections 16 through which the transport vehicle 2 is desired to pass, and one end point 46 on the basis of the input data of the input device 105. The designation unit 306 sequentially designates the plurality of intersections 16 according to the order in which the transport vehicle 2 is desired to pass.

Based on the start point 45, the intersections 16, and the end point 46 designated by the designation unit 306, the connection unit 307 connects the traveling path outline 41 stored in the traveling path storing unit 301 and the intersection outline 42 stored in the intersection storing unit 302 to generate the traveling area outline 40. The connection unit 307 connects the traveling path outline 41 and the intersection outline 42 on the basis of the local coordinate system that defines the position of the traveling path outline 41 and the position of the intersection outline 42.

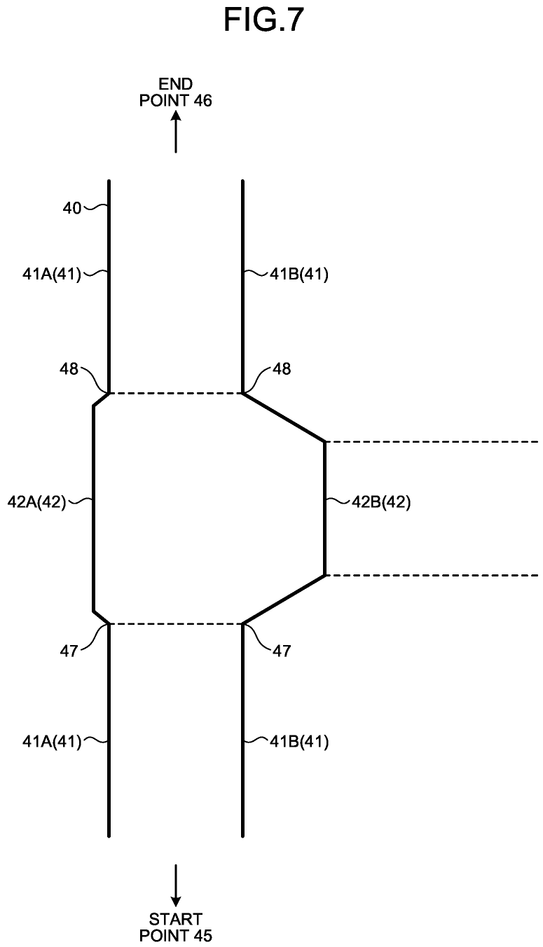

FIG. 7 is a schematic diagram for explaining processing of the connection unit 307 according to the embodiment. Processing of connecting the intersection outline 42 and the pair of traveling path outlines 41 adjacent to the intersection outline 42 will be described with reference to FIG. 7. As described above, the intersection outline 42 includes the intersection outline 42A on one end side and the intersection outline 42B on the other end side. The intersection outline 42 has a first end 47 close to the start point 45 and a second end 48 close to the end point 46. Each of the intersection outline 42A on one end side and the intersection outline 42B on the other end side has the first end 47 and the second end 48.

The traveling path outline 41 connected to the intersection outline 42 includes the traveling path outline 41 on the side of the start point 45 adjacent to the first end 47 and the traveling path outline 41 on the side of the end point 46 adjacent to the second end 48.

The connection unit 307 connects the first end 47 of the intersection outline 42 and the traveling path outline 41 on the start point 45 side. The connection unit 307 connects the second end 48 of the intersection outline 42 and the traveling path outline 41 on the end point 46 side.

As described above, the traveling path outline 41 includes the traveling path outline 41A on one end side and the traveling path outline 41B on the other end side.

The connection unit 307 connects the first end 47 of the intersection outline 42A on one end side and the traveling path outline 41A on the start point 45 side and on one end side. The connection unit 307 connects the second end 48 of the intersection outline 42A on one end side and the traveling path outline 41A on the end point 46 side and on one end side.

The connection unit 307 connects the second end 48 of the intersection outline 42B on the other end side and the traveling path outline 41B on the end point 46 side and on the other end side. The connection unit 307 connects the first end 47 of the intersection outline 42B on the other end side and the traveling path outline 41B on the start point 45 side and on the other end side.

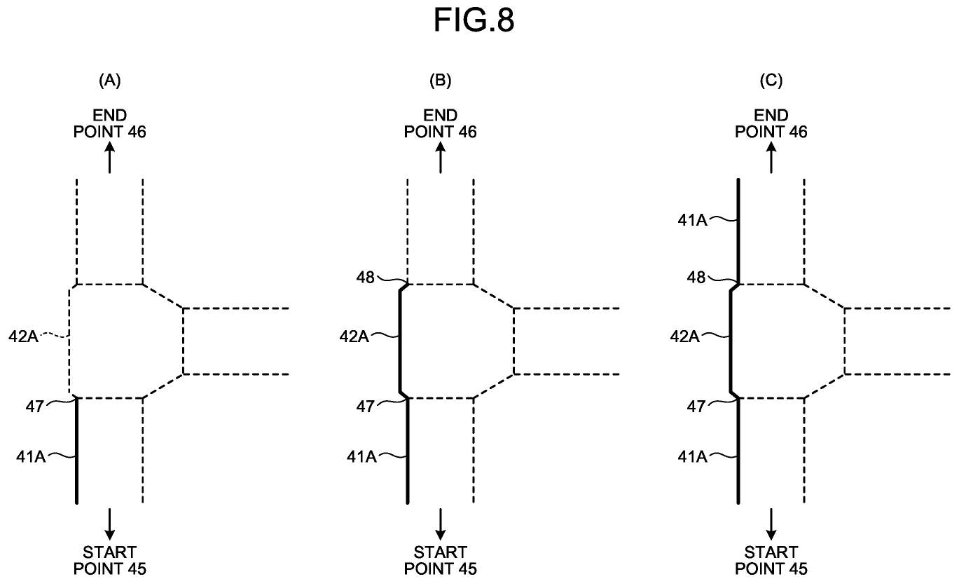

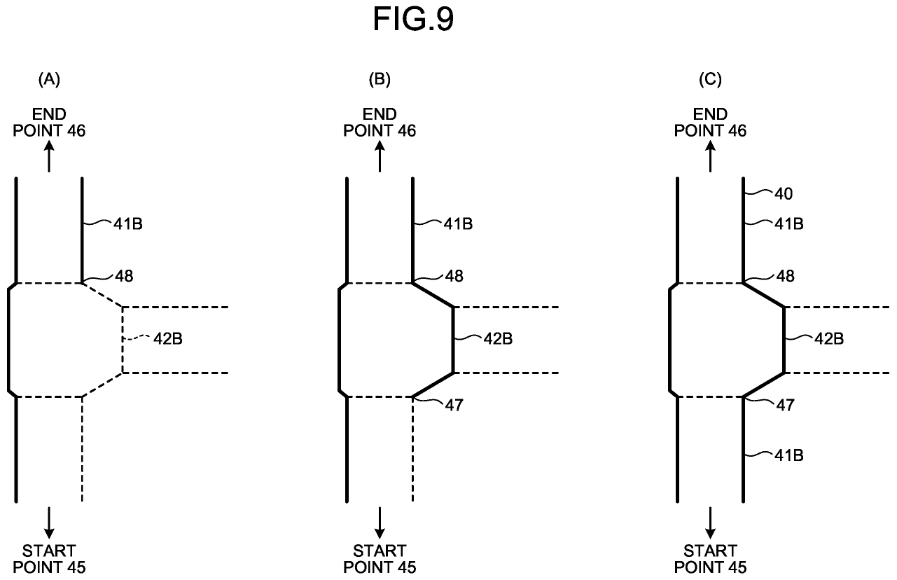

Each of FIGS. 8 and 9 is a schematic view for explaining a connection procedure between the traveling path outline 41 and the intersection outline 42 according to the embodiment. The connection unit 307 connects the traveling path outline 41A on one end side and the intersection outline 42A on one end side, and then connects the traveling path outline 41B on the other end side and the intersection outline 42B on the other end side. In the embodiment, the connection unit 307 connects the first end 47 of the intersection outline 42A on one end side and the traveling path outline 41A on the start point 45 side and on one end side, then connects the second end 48 of the intersection outline 42A on one end side and the traveling path outline 41A on the end point 46 side and on one end side, then connects the second end 48 of the intersection outline 42B on the other end side and the traveling path outline 41B on the end point 46 side and on the other end side, and then connects the first end 47 of the intersection outline 42B on the other end side and the traveling path outline 41B on the start point 45 side and on the other end side.

As illustrated in FIG. 8(A), the connection unit 307 connects the first end 47 of the intersection outline 42A on one end side and the traveling path outline 41A on the start point 45 side and on one end side. Next, as illustrated in FIG. 8(B), the connection unit 307 connects the intersection outline 42A on one end side and the traveling path outline 41A on the start point 45 side and on one end side. Next, as illustrated in FIG. 8(C), the connection unit 307 connects the second end 48 of the intersection outline 42A on one end side and the traveling path outline 41A on the end point 46 side and on one end side. As a result, the traveling path outline 41A on the start point 45 side and on one end side, the intersection outline 42A on one end side, and the traveling path outline 41A on the end point 46 side and on one end side are connected.

After the traveling path outline 41A on the start point 45 side and on one end side, the intersection outline 42A on one end side, and the traveling path outline 41A on the end point 46 side and on one end side are connected, as illustrated in FIG. 9(A), the connection unit 307 connects the second end 48 of the intersection outline 42B on the other end side and the traveling path outline 41B on the end point 46 side and on the other end side. Next, as illustrated in FIG. 9(B), the connection unit 307 connects the intersection outline 42B on the other end side and the traveling path outline 41B on the end point 46 side and on the other end side. Next, as illustrated in FIG. 9(C), the connection unit 307 connects the first end 47 of the intersection outline 42B on the other end side and the traveling path outline 41B on the start point 45 side and on the other end side. As a result, the traveling path outline 41B on the end point 46 side and on the other end side, the intersection outline 42B on the other end side, and the traveling path outline 41B on the start point 45 side and on the other end side are connected.

The traveling area outline 40 is generated by connecting the traveling path outline 41 and the intersection outline 42.

The reference line creating unit 308 sets the reference line 53 in the traveling area 10 on the basis of the traveling area outline 40 generated by the connection unit 307. The reference line 53 is an imaginary line set for creating the traveling course 50.

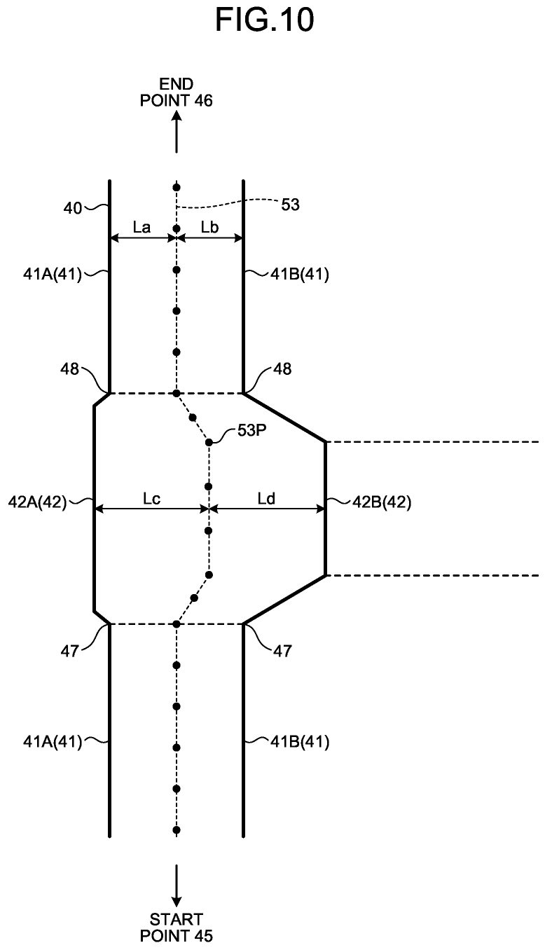

FIG. 10 is a schematic diagram for explaining processing of the reference line creating unit 308 according to the embodiment. The reference line creating unit 308 sets the reference line 53 on each of the traveling path 15 and the intersection 16. As illustrated in FIG. 10, the reference line 53 is an aggregate of a plurality of reference points 53P set at intervals. The interval between the reference points 53P may be uniform or may be different. The reference line 53 is defined by a trajectory passing through the plurality of reference points 53P. The position of the reference line 53 is defined in the local coordinate system.

In the traveling path 15, the reference line 53 is set substantially at the center of a region between the traveling path outline 41A on one end side and the traveling path outline 41B on the other end side. That is, the reference line 53 is set substantially at the center in the width direction of the traveling path 15. A distance La between the reference line 53 and the traveling path outline 41A on one end side is substantially equal to a distance Lb between the reference line 53 and the traveling path outline 41B on the other end side. The reference line 53 may be set at a portion different from the center in the region between the traveling path outline 41A on one end side and the traveling path outline 41B on the other end side. For example, the reference line 53 may be set at an end of a region between the traveling path outline 41A on one end side and the traveling path outline 41B on the other end side.

At the intersection 16, the reference line 53 is set substantially at the center of the region between the intersection outline 42A on one end side and the intersection outline 42B on the other end side. A distance Lc between the reference line 53 and the intersection outline 42A on one end side is substantially equal to a distance Ld between the reference line 53 and the intersection outline 42B on the other end side. Note that the reference line 53 may be set in a portion different from the center in the region between the intersection outline 42A on one end side and the intersection outline 42B on the other end side. For example, the reference line 53 may be set at an end of a region between the intersection outline 42A on one end side and the intersection outline 42B on the other end side.

The reference line 53 is created substantially parallel to the target traveling direction of the transport vehicle 2. For example, in the traveling path 15, the reference line 53 is set to extend along the traveling path 15. When the start point 45 is set in the loading place 11 and the end point 46 is set in the soil discharging place 12, the reference line 53 is set to connect the loading place 11 and the soil discharging place 12. One end of the reference line 53 is set between an entrance and an exit of the loading place 11 which is a departure place. The other end of the reference line 53 is set between an entrance and an exit of the soil discharging place 12 which is an arrival place.

The course data creating unit 309 creates course data including the traveling course 50 of the transport vehicle 2 on the basis of the traveling area outline 40. In the embodiment, the course data creating unit 309 creates the traveling course 50 on the basis of the reference line 53.

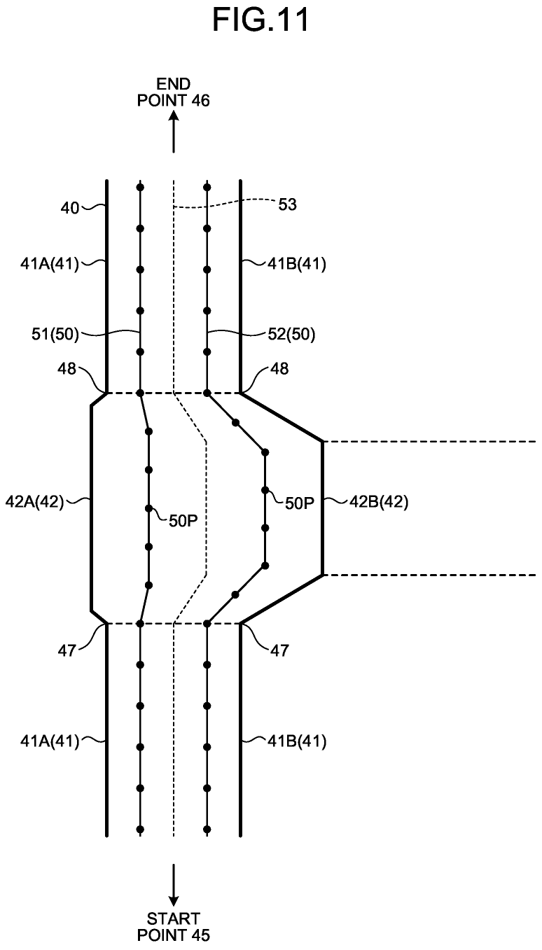

FIG. 11 is a schematic diagram for explaining processing of the course data creating unit 309 according to the embodiment. The traveling course 50 includes an imaginary line indicating a target traveling route of the transport vehicle 2. The traveling course 50 is set based on the reference line 53. In the example illustrated in FIG. 11, the traveling course 50 is set on both sides of the reference line 53. The traveling course 50 is set substantially parallel to the reference line 53. As illustrated in FIG. 11, the traveling course 50 is an aggregate of a plurality of course points 50P set at intervals. The interval between the course points 50P may be uniform or may be different. The traveling course 50 is defined by a trajectory passing through the plurality of course points 50P. The position of the traveling course 50 is defined in the local coordinate system.

In the traveling path 15, the first traveling course 51 is set between the reference line 53 and the traveling path outline 41A on one end side. In the traveling path 15, the second traveling course 52 is set between the reference line 53 and the traveling path outline 41B on the other end side. At the intersection 16, the first traveling course 51 is set between the reference line 53 and the intersection outline 42A on one end side. At the intersection 16, the second traveling course 52 is set between the reference line 53 and the intersection outline 42B on the other end side.

### Method of Creating Course Data

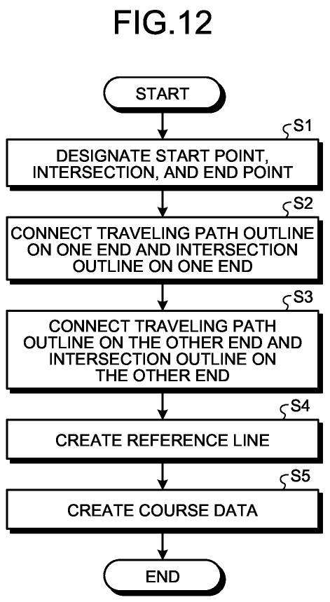

FIG. 12 is a flowchart illustrating a method of creating course data according to the embodiment. As described with reference to FIG. 6, an image of the work site is displayed on the display device 106. The administrator operates the input device 105 to designate a start point 45 of the transport vehicle 2 at the work site, intersections 16 through which the transport vehicle 2 passes, and an end point 46 of the transport vehicle 2. The designation unit 306 designates the start point 45 of the transport vehicle 2 at the work site, the intersections 16 through which the transport vehicle 2 passes, and the end point 46 of the transport vehicle 2 on the basis of the input data from the input device 105 (step S1).

The connection unit 307 connects the traveling path outline 41 indicating the outline of the traveling path 15 at the work site and the intersection outline 42 indicating the outline of the intersections 16 at the work site on the basis of the start point 45, the intersections 16, and the end point 46 designated in step S1 to generate the traveling area outline 40.

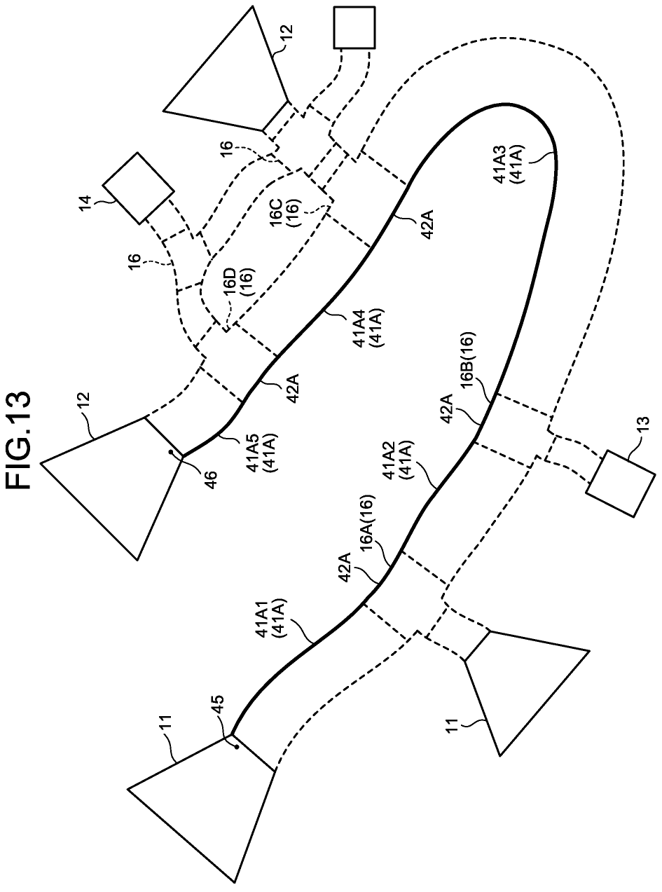

FIG. 13 is a schematic diagram for explaining a procedure for generating the traveling area outline 40 according to the embodiment. As illustrated in FIG. 13, the connection unit 307 sequentially connects the traveling path outline 41A on one end side and the intersection outline 42A on one end side from the start point 45 to the end point 46 on the basis of the start point 45, the intersections 16, and the end point 46 designated in step S2. The connection unit 307 sequentially connects the plurality of traveling path outlines 41A on one end side and the plurality of intersection outlines 42A on one end side on the basis of the order of the plurality of intersections 16 through which the transport vehicle 2 designated in step S1 passes (step S2).

As illustrated in FIG. 13, the connection unit 307 connects a traveling path outline 41A1 on one end side between the start point 45 and the first intersection 16A and the intersection outline 42A on one end side of the first intersection 16A. Next, the connection unit 307 connects the intersection outline 42A on one end side of the first intersection 16A and a traveling path outline 41A2 on one end side between the first intersection 16A and the second intersection 16B.

Next, the connection unit 307 connects the traveling path outline 41A2 on one end side and the intersection outline 42A on one end side of the second intersection 16B. Next, the connection unit 307 connects the intersection outline 42A on one end side of the second intersection 16B and a traveling path outline 41A3 on one end side between the second intersection 16B and the third intersection 16C.

Next, the connection unit 307 connects the traveling path outline 41A3 on one end side and the intersection outline 42A on one end side of the third intersection 16C. Next, the connection unit 307 connects the intersection outline 42A on one end side of the third intersection 16C and a traveling path outline 41A4 on one end side between the third intersection 16C and the fourth intersection 16D.

Next, the connection unit 307 connects the traveling path outline 41A4 on one end side and the intersection outline 42A on one end side of the fourth intersection 16D. Next, the connection unit 307 connects the intersection outline 42A on one end side of the fourth intersection 16D and a traveling path outline 41A5 on one end side between the fourth intersection 16D and the end point 46.

As a result, the plurality of traveling path outlines 41A on one end side and the plurality of intersection outlines 42A on one end side from the start point 45 to the end point 46 are sequentially connected.

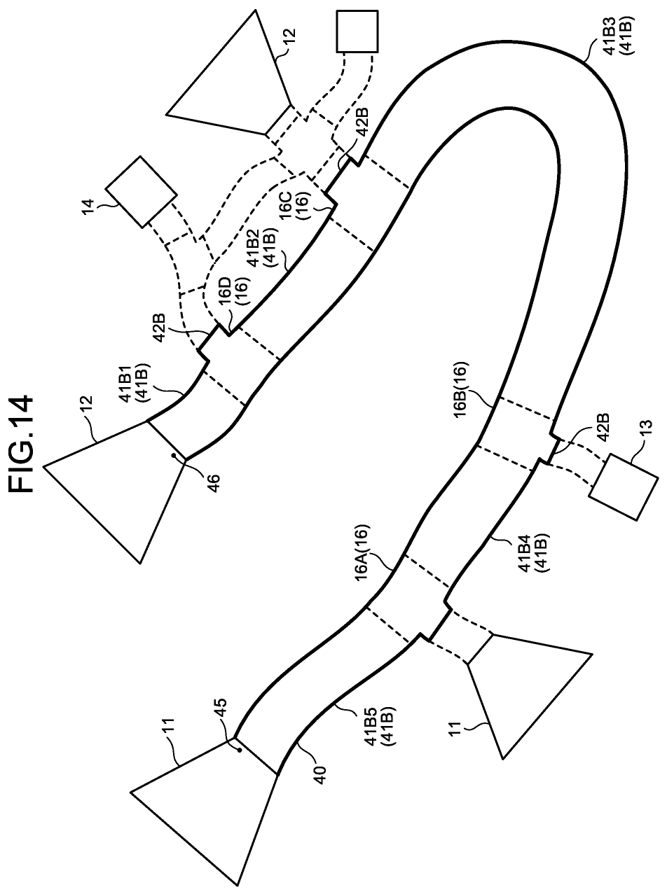

FIG. 14 is a schematic diagram for explaining a procedure for generating the traveling area outline 40 according to the embodiment. After the processing of step S2 is completed, as illustrated in FIG. 14, the connection unit 307 sequentially connects the traveling path outline 41B on the other end side and the intersection outline 42B on the other end side from the end point 46 to the start point 45 on the basis of the start point 45, the intersections 16, and the end point 46 designated in step S2. The connection unit 307 sequentially connects the plurality of traveling path outlines 41B on the other end side and the plurality of intersection outlines 42B on the other end side on the basis of the order of the plurality of intersections 16 through which the transport vehicle 2 designated in step S1 passes (step S3).

As illustrated in FIG. 14, the connection unit 307 connects a traveling path outline 41B1 on the other end side between the end point 46 and the fourth intersection 16D and the intersection outline 42B on the other end side of the fourth intersection 16D. Next, the connection unit 307 connects the intersection outline 42B on the other end side of the fourth intersection 16D and a traveling path outline 41B2 on the other end side between the fourth intersection 16D and the third intersection 16C.

Next, the connection unit 307 connects the traveling path outline 41B2 on the other end side and the intersection outline 42B on the other end side of the third intersection 16C. Next, the connection unit 307 connects the intersection outline 42B on the other end side of the third intersection 16C and a traveling path outline 41B3 on the other end side between the third intersection 16C and the second intersection 16B.

Next, the connection unit 307 connects the traveling path outline 41B3 on the other end side and the intersection outline 42B on the other end side of the second intersection 16B. Next, the connection unit 307 connects the intersection outline 42B on the other end side of the second intersection 16B and a traveling path outline 41B4 on the other end side between the second intersection 16B and the first intersection 16A.

Next, the connection unit 307 connects the traveling path outline 41B4 on the other end side and the intersection outline 42B on the other end side of the first intersection 16A. Next, the connection unit 307 connects the intersection outline 42B on the other end side of the first intersection 16A and a traveling path outline 41B5 on the other end side between the first intersection 16A and the start point 45.

As a result, the plurality of traveling path outlines 41B on the other end side and the plurality of intersection outlines 42B on the other end side from the end point 46 to the start point 45 are sequentially connected.

By the processing of step S2 and the processing of step S3, the traveling area outline 40 is formed.

After the traveling area outline 40 is formed, the reference line creating unit 308 creates the reference line 53 on the basis of the traveling area outline 40 (step S4).

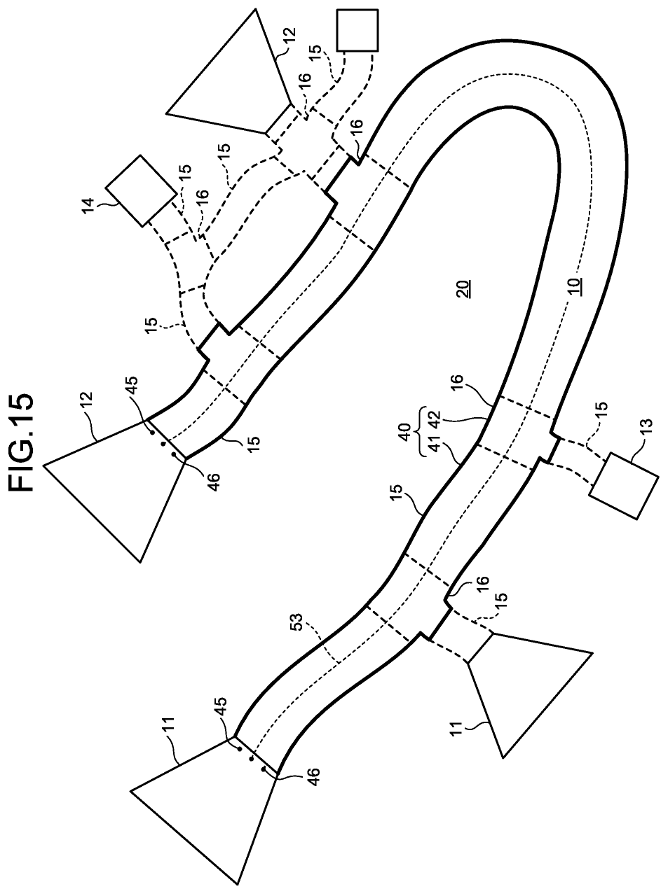

FIG. 15 is a schematic diagram for explaining the reference line 53 according to the embodiment. As illustrated in FIG. 15, the reference line creating unit 308 creates the reference line 53 on the basis of the traveling area outline 40. The reference line 53 is formed along the traveling path 15. The reference line 53 is formed at the center in the width direction of the traveling path 15.

After the reference line 53 is created, the course data creating unit 309 creates course data including the traveling course 50 on the basis of the reference line 53 (step S5).

In the embodiment, as illustrated in FIG. 2, the traveling course 50 is set on both sides of the reference line 53.

The course data creating unit 309 transmits the course data to the transport vehicle 2 via the communication system 4. The control device 30 of the transport vehicle 2 controls the traveling device 21 so that the transport vehicle 2 travels based on the course data.

### Update of Traveling Area Outline

The position or shape of the traveling area outline 40 is often changed. When the work site is a mine, the position or shape of the traveling area outline 40 is highly likely to change every day. When the position or shape of at least a part of the traveling area outline 40 changes, the survey vehicle 7 measures the survey line 44 of the changed part. For example, when the position of at least a part of the traveling path outline 41 changes, the survey vehicle 7 measures the position data of the changed part. Similarly, for example, when the position of at least a part of the intersection outline 42 changes, the survey vehicle 7 measures and obtains position data of the changed part. The position data measured by the survey vehicle 7 is transmitted to the management device 3 via the communication system 4.

The traveling path storing unit 301 can update the traveling path outline 41. The intersection storing unit 302 can update the intersection outline 42. The position data acquiring unit 303 updates the traveling path outline 41 stored in the traveling path storing unit 301 on the basis of the position data transmitted from the survey vehicle 7. The position data acquiring unit 303 updates the intersection outline 42 stored in the intersection storing unit 302 on the basis of the position data transmitted from the survey vehicle 7.

The connection unit 307 updates the traveling area outline 40 when at least one of the traveling path outline 41 and the intersection outline 42 is updated. That is, when at least one of the traveling path outline 41 and the intersection outline 42 is updated, the connection unit 307 reconnects the traveling path outline 41 and the intersection outline 42.

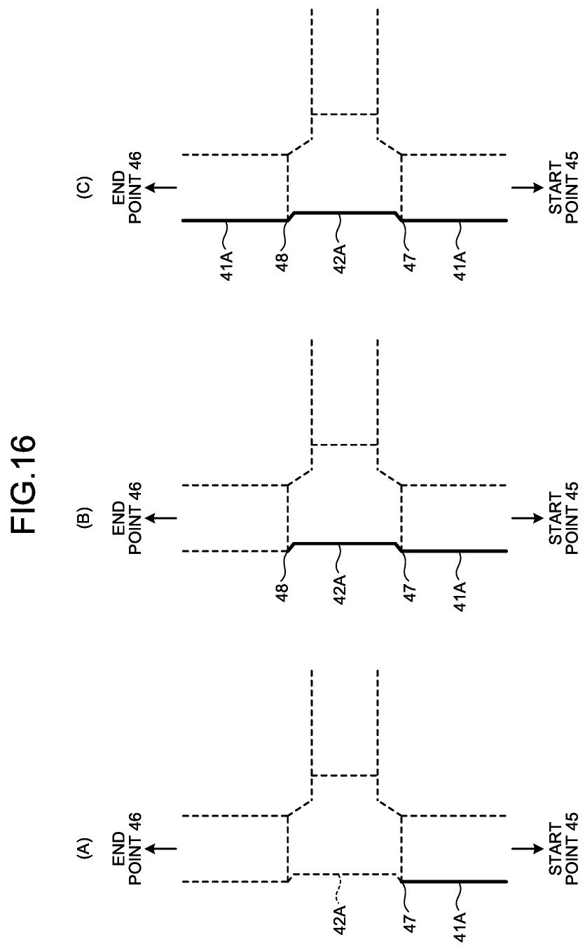

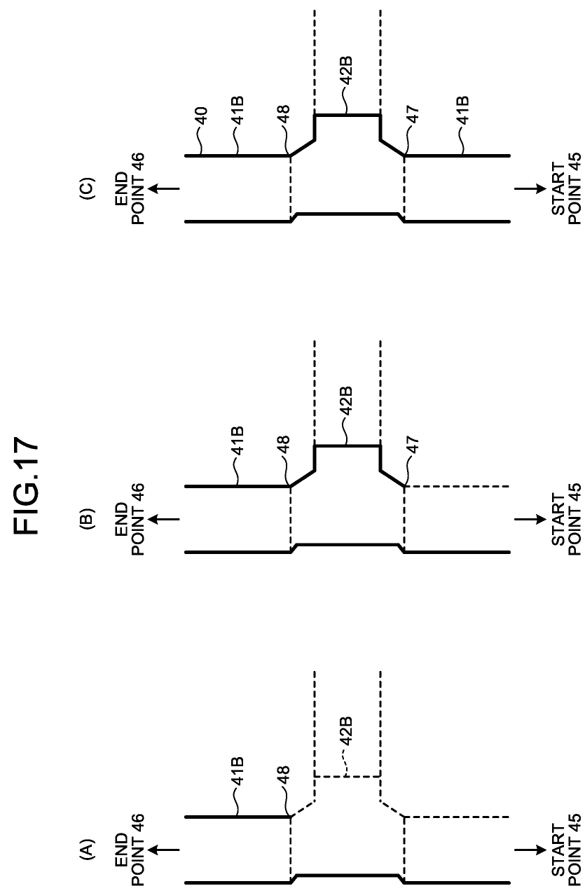

Each of FIGS. 16 and 17 is a schematic diagram for explaining processing of the connection unit 307 according to the embodiment. When the intersection outline 42 described with reference to FIGS. 8 and 9 is changed to the intersection outline 42 illustrated in FIGS. 16 and 17, the connection unit 307 reconnects the traveling path outline 41 and the intersection outline 42.

The connection procedure between the traveling path outline 41 and the intersection outline 42 after the intersection outline 42 is updated is similar to the connection procedure described with reference to FIGS. 8 and 9.

As illustrated in FIG. 16(A), the connection unit 307 connects the first end 47 of the intersection outline 42A on one end side and the traveling path outline 41A on the start point 45 side and on one end side. Next, as illustrated in FIG. 16(B), the connection unit 307 connects the intersection outline 42A on one end side and the traveling path outline 41A on the start point 45 side and on one end side. Next, as illustrated in FIG. 16(C), the connection unit 307 connects the second end 48 of the intersection outline 42A on one end side and the traveling path outline 41A on the end point 46 side and on one end side. As a result, the traveling path outline 41A on the start point 45 side and on one end side, the intersection outline 42A on one end side, and the traveling path outline 41A on the end point 46 side and on one end side are connected.

Next, as illustrated in FIG. 17(A), the connection unit 307 connects the second end 48 of the intersection outline 42B on the other end side and the traveling path outline 41B on the end point 46 side and on the other end side. Next, as illustrated in FIG. 17(B), the connection unit 307 connects the intersection outline 42B on the other end side and the traveling path outline 41B on the end point 46 side and on the other end side. Next, as illustrated in FIG. 17(C), the connection unit 307 connects the first end 47 of the intersection outline 42B on the other end side and the traveling path outline 41B on the start point 45 side and on the other end side. As a result, the traveling path outline 41B on the end point 46 side and on the other end side, the intersection outline 42B on the other end side, and the traveling path outline 41B on the start point 45 side and on the other end side are connected.

Note that the traveling area outline 40 does not need to be updated every time at least one of the traveling path outline 41 and the intersection outline 42 is updated. When the traveling course 50 is created or updated, the latest traveling area outline 40 may be generated based on the latest traveling path outline 41 stored in the traveling path storing unit 301 and the latest intersection outline 42 stored in the intersection storing unit 302.

### Effect

As described above, according to the embodiment, when the traveling path 15 and the intersection 16 exist at the work site, each of the traveling path outline 41 and the intersection outline 42 is measured. The measured traveling path outline 41 is stored in the traveling path storing unit 301. The measured intersection outline 42 is stored in the intersection storing unit 302. By designating the start point 45 of traveling of the transport vehicle 2, the intersections 16 through which the transport vehicle 2 passes, and the end point 46 of traveling of the transport vehicle 2, the connection unit 307 can connect the traveling path outline 41 and the intersection outline 42 to automatically generate the traveling area outline 40 of the transport vehicle 2. As a result, the course data creating unit 309 can smoothly set the traveling course 50 of the transport vehicle 2 on the basis of the traveling area outline 40.

When at least one intersection 16 exists between the start point 45 and the end point 46, the traveling course 50 is created on each of the plurality of traveling paths 15. As in the example illustrated in FIG. 2 and the like, when four intersections 16 exist between the start point 45 and the end point 46, the traveling course 50 is created on each of the five traveling paths 15. Even if the traveling course 50 is automatically set in each of the plurality of traveling paths 15 on the basis of the shape of each of the plurality of traveling paths 15, when the administrator of the control facility 5 performs the work of connecting the plurality of traveling courses 50 at the intersections 16, the processing of creating the traveling course 50 from the start point 45 to the end point 46 may be complicated. In the example illustrated in FIG. 2 and the like, the number of intersections 16 existing between the start point 45 and the end point 46 is four, but in an actual mine, there is a high possibility that the number of intersections 16 existing between the start point 45 and the end point 46 is large. When the number of intersections 16 increases, the administrator needs to perform the work of connecting the plurality of traveling courses 50 at the intersections 16 many times, and thus the work becomes very complicated. In the embodiment, both the processing of setting the traveling course 50 in each of the plurality of traveling paths 15 and the processing of setting the traveling course 50 in each of the plurality of intersections 16 are automatically performed. Therefore, even when at least one intersection 16 exists between the start point 45 and the end point 46, the processing of creating the traveling course 50 from the start point 45 to the end point 46 is efficiently performed.

In the embodiment, the position of the traveling path outline 41 is defined in the local coordinate system. The position of the intersection outline 42 is also defined in the local coordinate system. Therefore, the connection unit 307 can appropriately connect the end of the traveling path outline 41 and the end of the intersection outline 42 on the basis of the local coordinate system that defines the position of the traveling path outline 41 and the position of the intersection outline 42.

The intersection outline 42 has the first end 47 close to the start point 45 and the second end 48 close to the end point 46. The traveling path outline 41 includes the traveling path outline 41 on the side of the start point 45 adjacent to the first end 47 and the traveling path outline 41 on the side of the end point 46 adjacent to the second end 48. The connection unit 307 connects the first end 47 and the traveling path outline 41 on the start point 45 side, and connects the second end 48 and the traveling path outline 41 on the end point 46 side, so that the traveling area outline 40 can be appropriately generated.

The traveling path outline 41 includes a traveling path outline 41A on one end side in the width direction of the traveling path 15 and a traveling path outline 41B on the other end side in the width direction. The intersection outline 42 includes an intersection outline 42A on one end side connected to the traveling path outline 41A on one end side and an intersection outline 42B on the other end side connected to the traveling path outline 41B on the other end side. As a result, the traveling path 15 is set between the traveling path outline 41A on one end side and the traveling path outline 41B on the other end side. The intersection 16 is set between the intersection outline 42A on one end side and the intersection outline 42B on the other end side.

The connection unit 307 connects the traveling path outline 41A on one end side and the intersection outline 42A on one end side, and then connects the traveling path outline 41B on the other end side and the intersection outline 42B on the other end side. As a result, the calculation load on the connection unit 307 at the time of generating the traveling area outline 40 is suppressed.

The connection unit 307 connects the first end 47 of the intersection outline 42A on one end side and the traveling path outline 41A on the start point 45 side and on one end side, then connects the second end 48 of the intersection outline 42A on one end side and the traveling path outline 41A on the end point 46 side and on one end side, then connects the second end 48 of the intersection outline 42B on the other end side and the traveling path outline 41B on the end point 46 side and on the other end side, and then connects the first end 47 of the intersection outline 42B on the other end side and the traveling path outline 41B on the start point 45 side and on the other end side. After the connection between the traveling path outline 41A on one end side corresponding to the outward path and the intersection outline 42A on one end side is finished, the traveling path outline 41B on the other end side corresponding to the return path and the intersection outline 42B on the other end side are connected, so that the calculation load on the connection unit 307 at the time of generating the traveling area outline 40 is suppressed.

The connection unit 307 sequentially connects the traveling path outline 41A on one end side and the intersection outline 42A on one end side from the start point 45 to the end point 46, and then sequentially connects the traveling path outline 41B on the other end side and the intersection outline 42B on the other end side from the end point 46 to the start point 45. When the traveling path outline 41A on one end side corresponding to the outward path and the intersection outline 42A on one end side are connected, the connection unit 307 can efficiently generate the traveling area outline 40 by connecting them all at once from the start point 45 to the end point 46. Similarly, when the traveling path outline 41B on the other end side corresponding to the return path and the intersection outline 42B on the other end side are connected, the connection unit 307 can efficiently generate the traveling area outline 40 by connecting them all at once from the end point 46 to the start point 45.

The designation of the start point 45, the intersections 16 through which the transport vehicle 2 passes, and the end point 46 is performed by the input device 105. The administrator can operate the input device 105 to designate the start point 45, the intersections 16 through which the transport vehicle 2 passes, and the end point 46.

When the work site is a mine, at least a part of the traveling path outline 41 or at least a part of the intersection outline 42 may change every day. When at least one of the traveling path outline 41 and the intersection outline 42 is updated, the connection unit 307 reconnects the traveling path outline 41 and the intersection outline 42 and updates the traveling area outline 40 to the latest state. Thus, the course data creating unit 309 can create an appropriate traveling course 50 on the basis of the traveling area outline 40 in the latest state.

### Other Embodiments

In the above-described embodiment, each of the position of the traveling path outline 41 and the position of the intersection outline 42 may be defined in the global coordinate system.

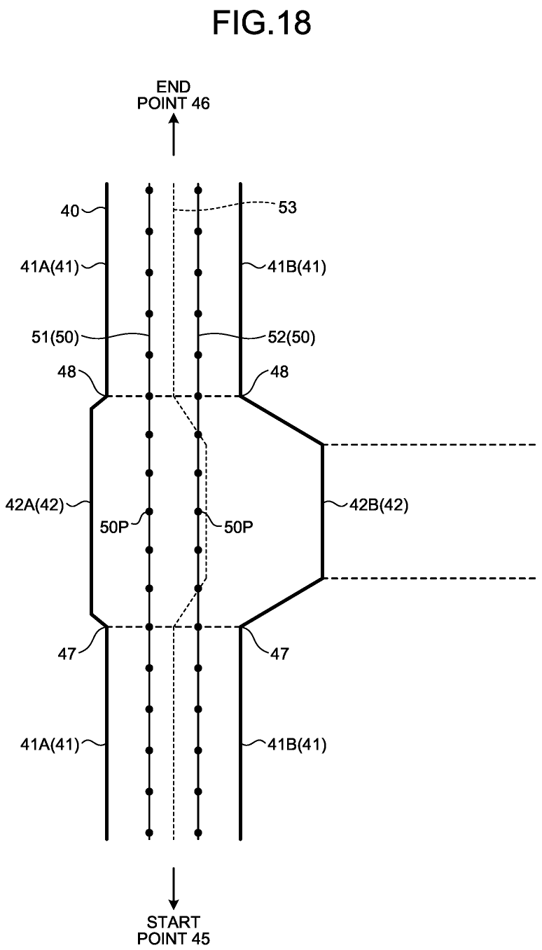

In the embodiment described above, for example, as described with reference to FIG. 11, the traveling course 50 is set on both sides of the reference line 53. The traveling course 50 may be set to cross the reference line 53. FIG. 18 is a schematic diagram for explaining processing of the course data creating unit 309 according to the modification. As illustrated in FIG. 18, when the reference line 53 is bent, the course data creating unit 309 can set the traveling course 50 so as to cross the reference line 53. In the example illustrated in FIG. 18, the second traveling course 52 and the reference line 53 cross each other. Each of the first traveling course 51 and the second traveling course 52 is straight. Even when the reference line 53 is bent, the transport vehicle 2 can travel at high speed by setting the traveling course 50 straight. This suppresses a decrease in generation property at the work site.

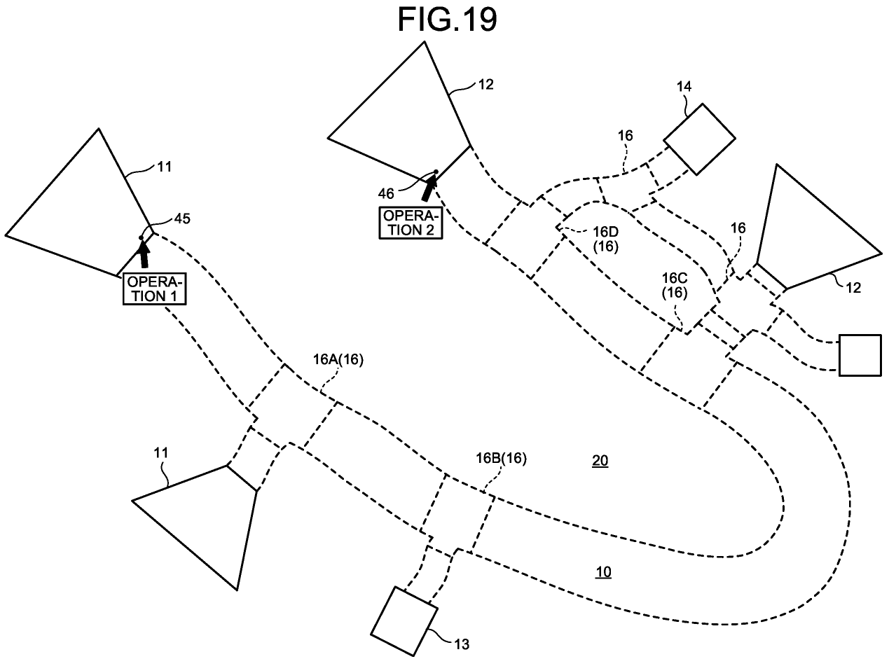

In the above-described embodiment, the designation unit 306 designates the start point 45, the intersections 16 through which the transport vehicle 2 passes, and the end point 46. The designation unit 306 may designate the start point 45 and the end point 46 and may not designate the intersections 16. FIG. 19 is a schematic diagram for explaining processing of the designation unit 306 according to the modification. The designation unit 306 designates the start point 45 and the end point 46 on the basis of the input data from the input device 105. The input device 105 is operated by the administrator to create input data. As illustrated in FIG. 19, the display control unit 305 causes the display device 106 to display the image of the work site including the traveling area 10. While checking the image of the work site displayed on the display device 106, the administrator operates the input device 105 to designate the start point 45 and the end point 46. In the example illustrated in FIG. 19, the administrator first designates the start point 45 by operating the input device 105 (operation 1). After designating the start point 45, the administrator operates the input device 105 to designate the end point 46 (operation 2). The designation unit 306 designates one start point 45 and one end point 46 on the basis of the input data of the input device 105. The designation unit 306 can calculate the shortest route connecting the start point 45 and the end point 46 by the Dijkstra method or the like on the basis of a road network indicating the network of the traveling path 15, and automatically select the intermediate point on the shortest route. The connection unit 307 can generate the traveling area outline 40 by connecting the traveling path outline 41 stored in the traveling path storing unit 301 and the intersection outline 42 stored in the intersection storing unit 302 on the basis of the start point 45 and the end point 46 designated by the designation unit 306 and the intermediate point selected by the designation unit 306.

In the above-described embodiment, the start point 45 is set to the loading place 11 or the soil discharging place 12, and the end point 46 is set to the soil discharging place 12 or the loading place 11. The start point 45 may be designated to a first loading place 11 and the end point 46 may be designated to a second loading place 11. Each of the start point 45 and the end point 46 may be designated to the same loading place 11. Note that the start point 45 may be designated to a first soil discharging place 12, and the end point 46 may be designated to a second soil discharging place 12. Each of the start point 45 and the end point 46 may be designated to the same soil discharging place 12.

Note that the start point 45 does not need to be set to the loading place 11 or the soil discharging place 12. The start point 45 may be set to a part of the traveling path 15 or to the intersection 16. Furthermore, the start point 45 may be set to the parking lot 13 or the oil supply station 14. The end point 46 does not need to be set to the soil discharging place 12 or the loading place 11. The end point 46 may be set to a part of the traveling path 15 or to the intersection 16. Further, the end point 46 may be set to the parking lot 13 or the oil supply station 14. That is, each of the start point 45 and the end point 46 can be set to an arbitrary position in the traveling area 10.

In the above-described embodiment, the reference line 53 is created based on the traveling area outline 40, and the traveling course 50 is created based on the reference line 53. The reference line 53 does not need to be created. For example, the traveling course 50 may be smoothly created at a position offset from the traveling area outline 40 by a specified amount.

### REFERENCE SIGNS LIST

1 MANAGEMENT SYSTEM
2 TRANSPORT VEHICLE
3 MANAGEMENT DEVICE
4 COMMUNICATION SYSTEM
5 CONTROL FACILITY
6 WIRELESS COMMUNICATION DEVICE
7 SURVEY VEHICLE
8 POSITION DETECTION DEVICE
9 WIRELESS COMMUNICATION DEVICE
10 TRAVELING AREA
11 LOADING STATION
12 SOIL DISCHARGING PLACE
13 PARKING LOT
14 OIL SUPPLY STATION
15 TRAVELING PATH
16 INTERSECTION
16A FIRST INTERSECTION
16B SECOND INTERSECTION
16C THIRD INTERSECTION
16D FOURTH INTERSECTION
17 LOADER
18 CRUSHER
20 PROHIBITED AREA
21 TRAVELING DEVICE
22 VEHICLE BODY
23 DUMP BODY
24 DRIVE DEVICE
25 BRAKE DEVICE
26 STEERING DEVICE
27 WHEEL
27F FRONT WHEEL
27R REAR WHEEL
28 POSITION DETECTION DEVICE
29 WIRELESS COMMUNICATION DEVICE
30 CONTROL DEVICE
40 TRAVELING AREA OUTLINE
41 TRAVELING PATH OUTLINE
41A TRAVELING PATH OUTLINE ON ONE END SIDE
41B TRAVELING PATH OUTLINE ON THE OTHER END SIDE
41P TRAVELING PATH OUTLINE POINT
42 INTERSECTION OUTLINE
42A INTERSECTION OUTLINE ON ONE END SIDE
42B INTERSECTION OUTLINE ON THE OTHER END SIDE
42P INTERSECTION OUTLINE POINT
43 BOUNDARY LINE
44 SURVEY LINE
45 START POINT
46 END POINT
47 FIRST END
48 SECOND END
50 TRAVELING COURSE
50P COURSE POINT
51 FIRST TRAVELING COURSE
52 SECOND TRAVELING COURSE
53 REFERENCE LINE
53P REFERENCE POINT
101 PROCESSOR
102 MAIN MEMORY
103 STORAGE
104 INTERFACE
105 INPUT DEVICE
106 DISPLAY DEVICE
300 STORAGE UNIT
301 TRAVELING PATH STORING UNIT
302 INTERSECTION STORING UNIT
303 POSITION DATA ACQUIRING UNIT
304 INPUT DATA ACQUIRING UNIT
305 DISPLAY CONTROL UNIT
306 DESIGNATION UNIT
307 CONNECTION UNIT
308 REFERENCE LINE CREATING UNIT
309 COURSE DATA CREATING UNIT

1. A management system for a transport vehicle, the management system comprising:
a storage unit that stores a traveling path outline indicating an outline of a traveling path at a work site and an intersection outline indicating an outline of an intersection at the work site;
a designation unit that designates a start point of traveling of the transport vehicle and an end point of traveling of the transport vehicle at the work site; and
a connection unit that generates a traveling area outline by connecting the traveling path outline and the intersection outline on a basis of the start point and the end point designated by the designation unit.

2. The management system for a transport vehicle according to claim 1, wherein
the connection unit connects the traveling path outline and the intersection outline on a basis of a coordinate system that defines a position of the traveling path outline and a position of the intersection outline.

3. The management system for a transport vehicle according to claim 1 , wherein
the intersection outline has a first end close to the start point and a second end close to the end point,
the traveling path outline includes a traveling path outline on a start point side adjacent to the first end and a traveling path outline on an end point side adjacent to the second end, and
the connection unit connects the first end and the traveling path outline on the start point side, and connects the second end and the traveling path outline on the end point side.

4. The management system for a transport vehicle according to claim 3, wherein
the traveling path outline includes a traveling path outline on one end side in a width direction of the traveling path and a traveling path outline on the other end side, and
the intersection outline includes an intersection outline on one end side connected to the traveling path outline on one end side and an intersection outline on the other end side connected to the traveling path outline on the other end side.

5. The management system for a transport vehicle according to claim 4, wherein
the connection unit connects the traveling path outline on one end side and the intersection outline on one end side, and then connects the traveling path outline on the other end side and the intersection outline on the other end side.

6. The management system for a transport vehicle according to claim 5, wherein
the connection unit connects the first end of the intersection outline on one end side and the traveling path outline on the start point side and on one end side, then connects the second end of the intersection outline on one end side and the traveling path outline on the end point side and on one end side, then connects the second end of the intersection outline on the other end side and the traveling path outline on the end point side and on the other end side, and then connects the first end of the intersection outline on the other end side and the traveling path outline on the start point side and on the other end side.

7. The management system for a transport vehicle according to claim 6, wherein
the connection unit sequentially connects the traveling path outline on one end side and the intersection outline on one end side from the start point to the end point, and then sequentially connects the traveling path outline on the other end side and the intersection outline on the other end side from the end point to the start point.

8. The management system for a transport vehicle according to claim 1, further comprising
an input device, wherein
the designation unit designates the start point and the end point on a basis of input data from the input device.

9. The management system for a transport vehicle according to claim 1, wherein
the storage unit is capable of updating the traveling path outline and the intersection outline, and
the connection unit updates the traveling area outline when at least one of the traveling path outline and the intersection outline is updated.

10. The management system for a transport vehicle according to claim 1, wherein
the designation unit designates an intersection through which the transport vehicle passes, and
the connection unit generates the traveling area outline by connecting the traveling path outline and the intersection outline on a basis of the start point, the intersection, and the end point designated by the designation unit.

11. A management method for a transport vehicle, the management method comprising:
designating a start point of traveling of a transport vehicle and an end point of traveling of the transport vehicle at a work site on a basis of input data from an input device; and
generating a traveling area outline by connecting a traveling path outline indicating an outline of a traveling path of the work site and an intersection outline indicating an outline of an intersection of the work site on a basis of the designated start point and end point.
